(19) United States
(12) Patent Application Publication
(10) Pub. No.: US 2008/0151343 A1
(43) Pub. Date: Jun. 26, 2008

(54) APPARATUS INCLUDING A SCANNED BEAM IMAGER HAVING AN OPTICAL DOME

(75) Inventors: Robert J. Dunki-Jacobs, Mason, OH (US); Robert M. Trusty, Cincinnati, OH (US)

Correspondence Address: Mark P. Levy;Thompson Hine LLP, P.O. Box 8801, Dayton, OH, 45401-8801, US

(73) Assignee: ETHICON ENDO-SURGERY, INC., Cincinnati, OH (US)

(21) Appl. No.: 11/615,155

(22) Filed: Dec. 22, 2006

(51) Int. Cl. G02B 26/10

(52) U.S. Cl. 359/205

(57) ABSTRACT

A first apparatus includes a scanned beam imager. The scanned beam imager includes an optical dome and a dual-resonant-mirror scanner. The optical dome has an optical axis. The scanner is adapted to scan, about substantially orthogonal first and second axes, a beam of light through the optical dome within a field of view centered about the optical axis. The scanner has first-axis angular extremes and second-axis angular extremes. The optical dome has a variable optical power distribution. A second apparatus includes a scanned beam imager. The scanned beam imager includes an optical dome and a scanner. The optical dome has an optical axis. The scanner is adapted to scan a beam of light through the optical dome within a field of view centered about the optical axis. The optical dome has a coating, and the coating has a spatially variable transmittance distribution.

### FIELD OF THE INVENTION

The present invention is related generally to scanned beam imagers, and more particularly to a scanned beam imager having an optical dome.

### BACKGROUND OF THE INVENTION

An example of an endoscope application of a medical scanned laser beam imager is given in US Patent Application Publication 2005/0020926. The scanned laser beam imager includes a two-dimensional MEMS (micro-electromechanical system) scanner. The MEMS scanner is a dual-resonant-mirror scanner. The mirror scanner scans, about substantially orthogonal first and second axes, one or more light beams (such as light beams from red, green and blue lasers) through an optical dome at high speed in a pattern that covers an entire two-dimensional field of view or a selected region of a two-dimensional field of view. The scanned laser beam imager uses at least one light detector in creating a pixel image from the reflected light for display on a monitor. It is noted that FIG. 1 of US Patent Application Publication 2005/0020926 shows a schematic diagram of a scanned beam imager without an optical dome and that FIG. 12 of US Patent Application Publication 2005/0020926 shows a non-schematic side-elevational view of a portion of a scanned beam imager including the scanner and the optical dome.

In a scanned beam system, the imager's field of view (FOV) is defined by the angular extent of the beam excursion in each of the scanning axes. In some cases, the scanner's construction details preclude achieving angular excursions sufficient to support the FOV required by the intended medical application. Mechanical interference, optical interference and material properties can contribute to limited angular excursion.

In a dual resonant, scanned beam imager, the scanned beam moves in a Lissajous scan pattern with the scanned beam moving faster (both in angular velocity along each mirror axis and in linear velocity along the path projected on the scene by the scanned optical beam) near the optical axis of the optical dome and with the scanned beam moving slower near the angular extremes of the first and second axes about which the mirror scanner is oscillating. In one embodiment, the light detector samples at a time-constant rate which leads to spatial over-sampling (i.e., spatial extent of a first sampled optical beam projected on the scene overlaps the spatial extent of a second, time consecutive, optical beam projected on the scene) of pixel locations corresponding to the angular extremes of the first and second axes and under-sampling (i.e., the spatial extents of a first and second consecutively sampled optical beam as projected on the scene are completely non-overlapping and non-contiguous) of pixel locations corresponding to the optical axis.

Resolution of a scanned beam imaging system is related to the size of the scanned beam (beam diameter) and the spatial proximity of two consecutive samples. For a dual resonant, scanned beam imager, the achievable resolution is based on the most under-sampled portion of the scan pattern, typically along the optical axis. In practical surgical settings, the imager resolution in the region of the optical axis determines the imager's utility.

What is needed is an improved scanned beam imager having an optical dome.

### SUMMARY

A first expression of a first embodiment of the invention is for apparatus including a scanned beam imager. The scanned beam imager includes an optical dome and a dual-resonant-mirror scanner. The optical dome has an optical axis. The scanner is adapted to scan, about substantially orthogonal first and second axes, a beam of light through the optical dome within a field of view centered about the optical axis. The scanner has first-axis angular extremes and second-axis angular extremes. The optical dome has a variable optical power distribution.

A first expression of a second embodiment of the invention is for apparatus including a scanned beam imager. The scanned beam imager includes an optical dome and a scanner. The optical dome has an optical axis. The scanner is adapted to scan a beam of light through the optical dome within a field of view centered about the optical axis. The optical dome has a coating, and the coating has a spatially variable transmittance distribution.

Several benefits and advantages are obtained from one or more of the expressions of embodiments of the invention. In one example, the variable optical power distribution of the optical dome gives a larger field of view than would be given by a constant optical power distribution. In the same or a different example, the variable optical power distribution of the optical dome gives the scanned beam imager a smaller image resolution size proximate the optical axis than would be given by a constant optical power distribution. In one illustration, the spatially variable transmittance distribution of the coating of the optical dome is substantially inversely proportional to the spatially non-uniform output intensity of the scanned beam or the spatially non-uniform light sensitivity of at-least-one light detector of the scanned beam imager.

### BRIEF DESCRIPTION OF THE FIGURES

FIG. 1 is a schematic diagram of a first embodiment of the invention including a scanned beam imager having a dual-resonant-mirror scanner and having an optical dome with a variable optical power distribution, wherein a target to be imaged is also shown;

FIG. 2 is a view taken along lines 2-2 of FIG. 1 showing the dual-resonant-mirror scanner and orthogonal first and second axes about which the scanner is adapted to scan a beam of light;

FIG. 3 is a view taken along lines 3-3 of FIG. 1 showing the target and including a rectangle representing the field of view of the scanned beam imager;

FIG. 4 is a cross-sectional view of an alternate embodiment of the optical dome of FIG. 1 having a different variable optical power distribution;

FIG. 5 is a cross-sectional view of another alternate embodiment of the optical dome of FIG. 1 having another different variable optical power distribution;

FIG. 6 is a schematic diagram of a second embodiment of the invention including a scanned beam imager having a scanner and an optical dome, wherein the optical dome has a coating with a spatially variable transmittance distribution, and wherein a target is also shown;

FIG. 7 is a view taken along lines 7-7 of FIG. 6 showing the target and including a rectangle representing the field of view of the scanned beam imager; and

FIG. 8 is a cross-sectional view of an alternate embodiment of the optical dome of FIG. 6 having a coating with a different spatially variable transmittance distribution.

### DETAILED DESCRIPTION

Before explaining the several expressions of embodiments of the present invention in detail, it should be noted that each is not limited in its application or use to the details of construction and arrangement of parts illustrated in the accompanying drawings and description. The illustrative expressions of embodiments of the invention may be implemented or incorporated in other embodiments, variations and modifications, and may be practiced or carried out in various ways. Furthermore, unless otherwise indicated, the terms and expressions employed herein have been chosen for the purpose of describing the illustrative embodiments of the present invention for the convenience of the reader and are not for the purpose of limiting the invention.

It is further understood that any one or more of the following-described expressions of embodiments, examples, etc. can be combined with any one or more of the other following-described expressions of embodiments, examples, etc.

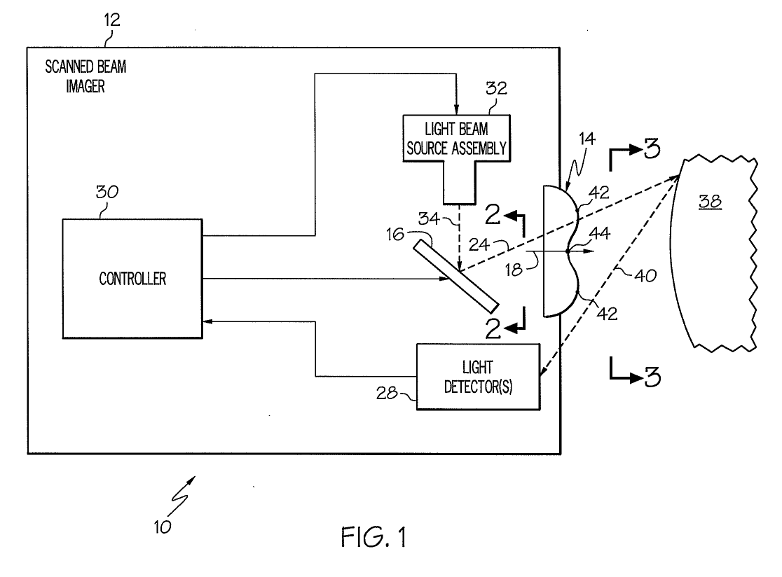

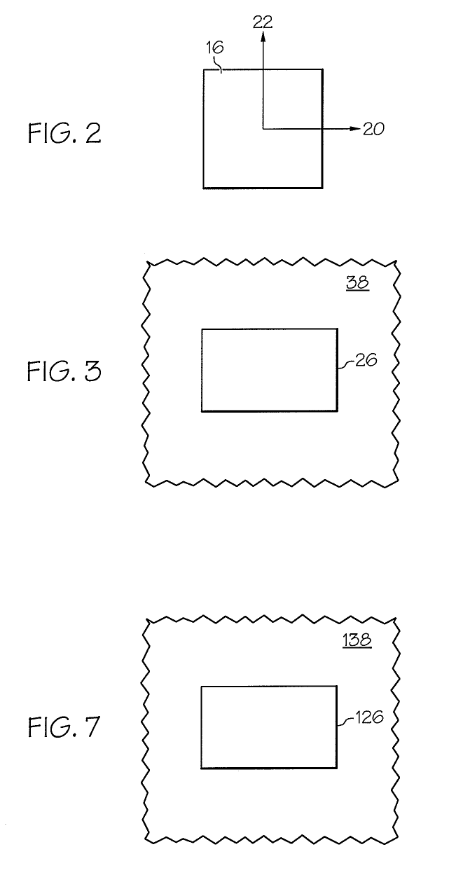

A first embodiment of the invention is shown in FIGS. 1-3. A first expression of the embodiment of FIGS. 1-3 is for apparatus 10 including a scanned beam imager 12. The scanned beam imager 12 includes an optical dome 14 and a dual-resonant-mirror scanner 16. The optical dome 14 has an optical axis 18. The scanner 16 is adapted to scan, about substantially orthogonal first and second axes 20 and 22, a beam of light 24 through the optical dome 14 within a field of view 26 centered about the optical axis 18. The scanner 16 has first-axis angular extremes and second-axis angular extremes. The optical dome 14 has a variable optical power distribution.

In one implementation of the first expression of the embodiment of FIGS. 1-3, the scanned beam imager 12 includes at least one light detector 28 and a controller 30, wherein the controller 30 is operatively connected to the scanner 16 and the at-least-one light detector 28, and wherein the controller 30 samples the at-least-one light detector 28 at a substantially time-constant rate. In one variation, the scanned beam imager 12 includes a light beam source assembly 32. In one example, the light beam source assembly 32 is a laser beam source assembly having red, green, and blue imaging lasers. In one modification, the light beam source assembly 32 outputs emitted light 34 (indicated by a dashed line having a directional arrowhead in FIG. 1), and the scanner 16 reflects such emitted light 34 as a scanned (light) beam 24 (indicated by a dashed line having a directional arrowhead in FIG. 1), in a Lissajous scan pattern, which is transmitted through the optical dome 14 and then is reflected by a target 38 (such as internal or external patient tissue) as reflected light 40 (indicated by a dashed line having a directional arrowhead in FIG. 1) directly or indirectly to the at-least-one light detector 28. In one example, the emitted light 34 is emitted as light pulses. As used in the present application, “reflected light 40” means light which has been detected by the at-least-one light detector 28 whether from true reflection, scattering, and/or refraction, etc. In one illustration, at least one optical fiber (not shown) receives the reflected light 40 and transmits it to the at-least-one light detector 28. It is noted that the unlabeled solid lines having directional arrowheads in FIG. 1 represent signals to and from the controller 30.

In one enablement of the first expression of the embodiment of FIGS. 1-3, the optical dome 14 has an optical power which is greater proximate first dome locations 42 corresponding to the angular extremes of at least one of the first and second axes 20 and 22 than proximate a second dome location 44 corresponding to the optical axis 18. It is noted that the first dome locations 42 shown in FIG. 1 are the first dome locations which correspond to the angular extremes of the first axis 20. In one variation, the optical power is greatest at the first dome locations 42. In one modification, the optical power is positive proximate the first dome locations 42. In one example, the optical power is negative proximate the second dome location 44. In one illustration, the scanned beam imager 12 is a scanned laser beam imager.

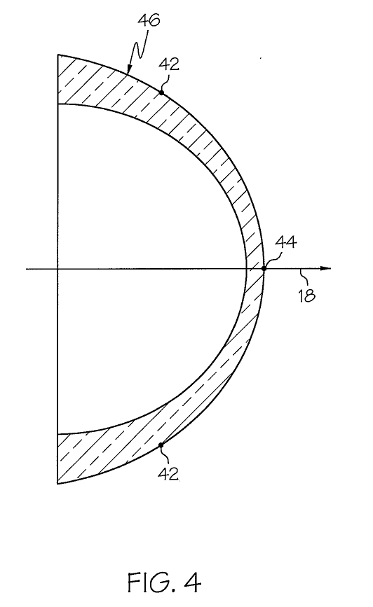

In one arrangement of the first expression of the embodiment of FIGS. 1-3, the variable optical power distribution gives a larger field of view 26 than would be given by a constant optical power distribution. In one variation, as shown in a first alternate embodiment of the optical dome 46 of FIG. 4, the optical dome 46 has an optical power which is positive proximate first dome locations 42 corresponding to the angular extremes of at least one of the first and second axes 20 and 22 and which is substantially zero proximate a second dome location 44 corresponding to the optical axis 18. In one modification, the optical power is most positive at the first dome locations 42 of the optical dome 14.

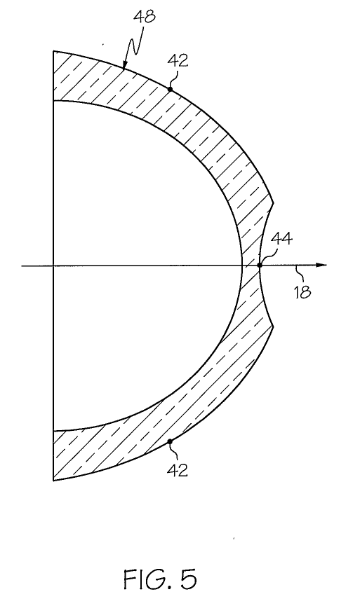

In the same or a different arrangement of the first expression of the embodiment of FIGS. 1-3, the variable optical power distribution gives the scanned beam imager 12 a smaller image resolution size proximate the optical axis 18 than would be given by a constant optical power distribution. In one variation, as shown in a second alternate embodiment of the optical dome 48 of FIG. 5, the optical dome 48 has an optical power which is substantially zero proximate first dome locations 42 corresponding to the angular extremes of at least one of the first and second axes 20 and 22 and which is negative proximate a second dome location 44 corresponding to the optical axis 18. In one modification, the optical power is most negative at the second dome location 44 of the optical dome 14.

In one employment of the first expression of the embodiment of FIGS. 1-3, the optical power distribution, in a spherical coordinate system, is a function of zenith and azimuth angles. The azimuth angle is an angle measured in the plane perpendicular to the optical axis 18 and whose origin is on the optical axis 18. The zenith angle is an angle measured from the optical axis 18 positively to the plane of the scanner 16 and whose origin is at the location of the scanner 16 on the optical axis 18. In one example, the optical power has a nominal value for a set of zenith and azimuth angles between a zenith angle and an azimuth angle corresponding to the optical axis 18 and zenith and azimuth angles corresponding to the first-axis angular extremes and the second-axis angular extremes, wherein the optical power is less than the nominal power at the optical axis 18 and the optical power is greater than the nominal power at the first-axis angular extremes and the second-axis angular extremes. In this example, the optical power is, in effect, a linear combination of an optical power distribution giving a larger field of view 26 and an optical power distribution giving a more uniform angular scanned beam velocity and hence a smaller image resolution size proximate the optical axis 18.

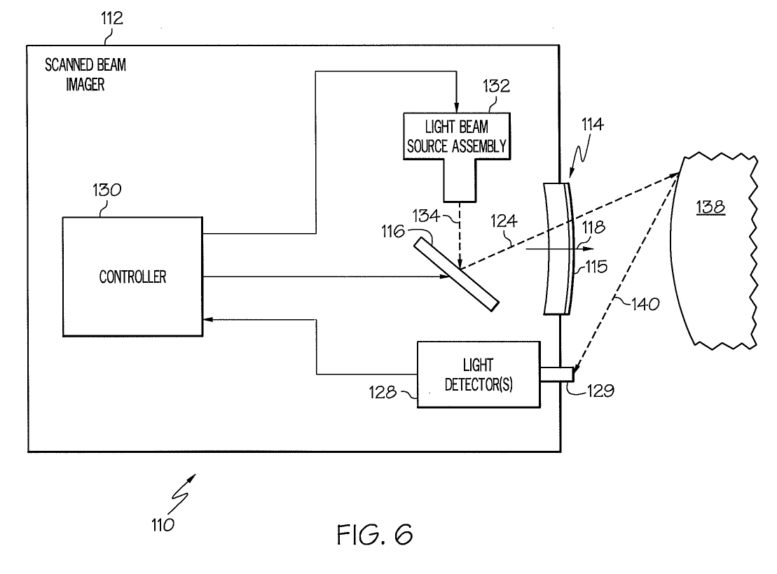

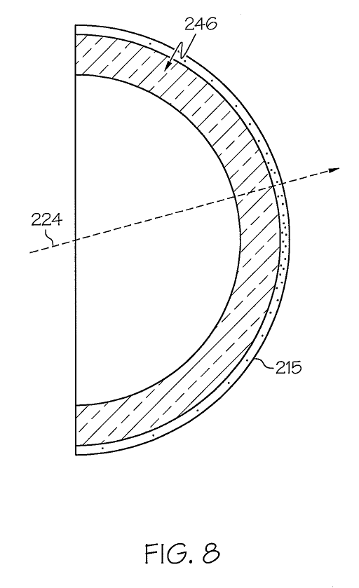

A second embodiment of the invention is shown in FIGS. 6-7. A first expression of the embodiment of FIGS. 6-7 is for apparatus 110 including a scanned beam imager 112. The scanned beam imager 112 includes an optical dome 114 and a scanner 116. The optical dome 114 has an optical axis 118. The scanner 116 is adapted to scan a beam of light 124 through the optical dome 114 within a field of view 126 centered about the optical axis 118. The optical dome 114 has a coating 115, wherein the coating 115 has a spatially variable transmittance distribution.

In one implementation of the first expression of the embodiment of FIGS. 6-7, the scanned beam imager 112 includes a light detector 128 and at-least-one optical fiber 129. The at-least-one optical fiber 129 has a spatially non-uniform light sensitivity and is operatively connected to the light detector 128. The transmittance distribution of the coating 115 is substantially inversely proportional to the spatially non-uniform light sensitivity of the at-least-one optical fiber 129.

In one variation, the scanned beam imager 112 includes a controller 130, wherein the controller 130 operatively connected to the scanner 116 and the light detector 128. In one modification, the scanned beam imager 112 includes a light beam source assembly 132, In one example, the light beam source assembly 132 is a laser beam source assembly having red, green, and blue imaging lasers. In one illustration, the light beam source assembly 132 outputs emitted light 134 (indicated by a dashed line having a directional arrowhead in FIG. 6), and the scanner 116 reflects such emitted light 134 as a scanned (light) beam 124 (indicated by a dashed line having a directional arrowhead in FIG. 6) which is transmitted through the optical dome 114 and then is reflected by a target 138 (such as internal or external patient tissue) as reflected light 140 (indicated by a dashed line having a directional arrowhead in FIG. 6) directly or indirectly to the light detector 128. In one example, the emitted light 134 is emitted as light pulses. As used in the present application, “reflected light 140” means light which has been detected by the light detector 128 whether from true reflection, scattering, and/or refraction, etc. In one illustration, the at least one optical fiber 129 receives the reflected light 140 and transmits it to the light detector 128. It is noted that the unlabeled solid lines having directional arrowheads in FIG. 6 represent signals to and from the controller 130.

In one deployment, as shown in an alternate embodiment of the optical dome 246 of FIG. 8, the optical dome 246 has a coating 215. In this deployment, the scanned (light) beam 224 has a spatially non-uniform output intensity, and the transmittance distribution of the coating 215 is substantially inversely proportional to the spatially non-uniform output intensity of the scanned (light) beam 224.

Several benefits and advantages are obtained from one or more of the expressions of embodiments of the invention. In one example, the variable optical power distribution of the optical dome gives a larger field of view than would be given by a constant optical power distribution. In the same or a different example, the variable optical power distribution of the optical dome gives the scanned beam imager a smaller image resolution size proximate the optical axis than would be given by a constant optical power distribution. In one illustration, the spatially variable transmittance distribution of the coating of the optical dome is substantially inversely proportional to the spatially non-uniform output intensity of the scanned beam or the spatially non-uniform light sensitivity of at-least-one light detector of the scanned beam imager.

While the present invention has been illustrated by a description of several expressions of embodiments, it is not the intention of the applicants to restrict or limit the spirit and scope of the appended claims to such detail. Numerous other variations, changes, and substitutions will occur to those skilled in the art without departing from the scope of the invention. It will be understood that the foregoing description is provided by way of example, and that other modifications may occur to those skilled in the art without departing from the scope and spirit of the appended Claims.

What is claimed is:

1. Apparatus comprising a scanned beam imager, wherein the scanned beam imager includes an optical dome and a dual-resonant-mirror scanner, wherein the optical dome has an optical axis, wherein the scanner is adapted to scan, about substantially orthogonal first and second axes, a beam of light through the optical dome within a field of view centered about the optical axis, wherein the scanner has first-axis angular extremes and second-axis angular extremes, and wherein the optical dome has a variable optical power distribution.

2. The apparatus of claim 1, also including at least one light detector and a controller, wherein the controller is operatively connected to the scanner and the at-least-one light detector, and wherein the controller samples the at-least-one light detector at a substantially time-constant rate.

3. The apparatus of claim 2, wherein the optical dome has an optical power which is greater proximate first dome locations corresponding to the angular extremes of at least one of the first and second axes than proximate a second dome location corresponding to the optical axis.

4. The apparatus of claim 3, wherein the optical power is greatest at the first dome locations.

5. The apparatus of claim 4, wherein the optical power is positive proximate the first dome locations.

6. The apparatus of claim 5, wherein the optical power is negative proximate the second dome location.

7. The apparatus of claim 1, wherein the scanned beam imager is a scanned laser beam imager.

8. Apparatus comprising a scanned beam imager, wherein the scanned beam imager includes an optical dome and a dual-resonant-mirror scanner, wherein the optical dome has an optical axis, wherein the scanner is adapted to scan, about substantially orthogonal first and second axes, a beam of light through the optical dome within a field of view centered about the optical axis, wherein the scanner has first-axis angular extremes and second-axis angular extremes, and wherein the optical dome has a variable optical power distribution which gives a larger field of view than would be given by a constant optical power distribution.

9. The apparatus of claim 8, also including at least one light detector and a controller, wherein the controller is operatively connected to the scanner and the at-least-one light detector, and wherein the controller samples the at-least-one light detector at a substantially time-constant rate.

10. The apparatus of claim 9, wherein the optical dome has an optical power which is positive proximate first dome locations corresponding to the angular extremes of at least one of the first and second axes and which is substantially zero proximate a second dome location corresponding to the optical axis.

11. The apparatus of claim 10, wherein the optical power is most positive at the first dome locations

12. The apparatus of claim 8, wherein the scanned beam imager is a scanned laser beam imager.

13. Apparatus comprising a scanned beam imager, wherein the scanned beam imager includes an optical dome and a dual-resonant-mirror scanner, wherein the optical dome has an optical axis, wherein the scanner is adapted to scan, about substantially orthogonal first and second axes, a beam of light through the optical dome within a field of view centered about the optical axis, wherein the scanner has first-axis angular extremes and second-axis angular extremes, and wherein the optical dome has a variable optical power distribution which gives the scanned beam imager a smaller image resolution size proximate the optical axis than would be given by a constant optical power distribution.

14. The apparatus of claim 13, also including at least one light detector and a controller, wherein the controller is operatively connected to the scanner and the at-least-one light detector, and wherein the controller samples the at-least-one light detector at a substantially time-constant rate.

15. The apparatus of claim 14, wherein the optical dome has an optical power which is substantially zero proximate first dome locations corresponding to the angular extremes of at least one of the first and second axes and which is negative proximate a second dome location corresponding to the optical axis.

16. The apparatus of claim 15, wherein the optical power is most negative at the second dome location.

17. The apparatus of claim 13, wherein the scanned beam imager is a scanned laser beam imager.

18. Apparatus comprising a scanned beam imager, wherein the scanned beam imager includes an optical dome and a scanner, wherein the optical dome has an optical axis, wherein the scanner is adapted to scan a beam of light through the optical dome within a field of view centered about the optical axis, wherein the optical dome has a coating, and wherein the coating has a spatially variable transmittance distribution.

19. The apparatus of claim 18, also including a light detector and at least one optical fiber having a spatially non-uniform light sensitivity and operatively connected to the light detector, wherein the transmittance distribution of the coating is substantially inversely proportional to the spatially non-uniform light sensitivity of the at-least-one optical fiber.

20. The apparatus of claim 18, wherein the scanned beam has a spatially non-uniform output intensity, and wherein the transmittance distribution of the coating is substantially inversely proportional to the spatially non-uniform output intensity of the scanned beam.
